(19) United States
(12) Patent Application Publication
(10) Pub. No.: US 2022/0300951 A1
(43) Pub. Date: Sep. 22, 2022

(54) Cryptocurrency Reward System

(71) Applicant: PREMASHANTH KUMALARASAN, TORONTO (CA)

(72) Inventor: PREMASHANTH KUMALARASAN, TORONTO (CA)

(21) Appl. No.: 17/202,367

(22) Filed: Mar. 16, 2021

(51) Int. Cl. G06Q 20/36; G06Q 20/06; G06Q 30/02

(52) U.S. Cl. CPC G06Q 20/3674; G06Q 20/065; G06Q 30/0236

(57) ABSTRACT

A method relates to a kind of novel intelligent wallets, which is an automated interconnection for creating and utilizing smart policies on a secured platform is provided. The system provides method for user to register or login at the platform and once secured login is achieved an interface is provided displaying information, history and analytics to user. Multiple types of advancements can be provided to user including but not limited to transfer of currency, receivals of currency, updation of balance, earning and utilization of rewards.

### BACKGROUND

### Field of the Invention

The invention relates to the field of digital currency, in particular to a wallet and reward system and more specifically, to a special type of cryptocurrency wallet which holds cryptocurrency/transfer and provides a feature to get rewards system.

### Description of the Related Art

In recent times, blockchain currencies have seen increased usage over traditional fiat currencies by consumers who value anonymity and security. Currencies that use a blockchain, such as cryptographic currencies (“cryptocurrencies”), offer consumers a currency that is decentralized and relatively anonymous and secure in its use. For example, a transaction that is posted to a blockchain may not require any information regarding the sender or recipient of the currency, and thus may enable the payer and payee of a transaction to retain anonymity. Such an aspect of blockchain transactions may be highly desirable for consumers that wish to maintain their privacy and may help reduce the likelihood of fraud due to theft of their information.

Digital currency is an alternative currency in the form of electronic currency, both digital gold currency and cryptocurrency belong to digital currency, and he cannot be completely equivalent to virtual currency in a virtual world, because it is more applied to real goods and services transactions. The cryptocurrency is digital currency using a cryptographic algorithm; most of cryptographic operations continue to use the mature asymmetric encryption system in the field of information security to digest and sign data. Regarding cryptocurrency and improvements in cryptocurrency there are multiple solutions have been proposed.

There are multiple inventions that have been proposed in prior art in similar regards. For instance, a kind of method and hardware wallet using hardware realization digital cash wallet bearing Chinese patent 1,074,80986B is issued to Chinese inventor. The present: invention relates to digital cash fields, in particular to a kind of method and hardware wallet using hardware realization digital cash wallet, this method comprises: the instruction to be received from host computer such as hardware wallet, when receive query the balance instruct when, hardware wallet according in secure storage areas master key and preset sub-key index sub-key pair generated by key derivation algorithm, and account address is generated according to the sub-public key of sub-key centering, account address and sub-key index are bound and returns to host computer; When receiving trading instruction, hardware wallet generates sub-key pair by key derivation algorithm according to the sub-key index in the master key and trading instruction in secure storage areas, and the transaction data in trading instruction is signed to obtain signature result using the sub-private key of sub-key centering, transaction evidence is generated according to the sub-public key of sub-key centering and the signature result, and transaction evidence is returned into host computer, present method solves the safety issues that key saves.

Another patent on A kind of information processing method, device, hardware wallet and system bearing Chinese patent 1,086,65250A is issued to Chinese inventor. The embodiment of the present invention provides a kind of information processing method, device, hardware wallet and system, wherein this method includes: Receive the first instruction that request input by user executes wallet account operation; When first instruction is predetermined instruction, which is sent to safety chip, which includes at least two respectively from the different corresponding regions of wallet pattern, is physically completely cut off between each region at least two region; Region corresponding with current wallet pattern in the safety chip receives the predetermined instruction; it is handled accordingly according to the predetermined instruction. As a result, the processing of different wallet patterns can be executed in different zones, to realize cold and hot wallet integration respectively; In addition, since there is no other application connected to the network, the security risk of hot money packet can be reduced.

Another patent on Hardware wallet and holder identity verification method thereof bearing Chinese patent 1,066,51363B is issued to Chinese inventor. The invention discloses a hardware wallet and a holder identity verification method thereof, and relates to the field of digital money, wherein the hardware wallet comprises a virtual machine, a biological characteristic authentication module and a plurality of wallet applications, a private key is stored in each wallet application, the hardware wallet records biological characteristics for verifying the identity of a hardware wallet holder corresponding to each wallet application through the virtual machine and the biological characteristic authentication module, and only after the identity of the hardware wallet holder corresponding to the current wallet application is verified, the private key in the current wallet application can be used for conducting transaction on the digital money.

Another patent on a kind of novel intelligent hardware wallet bearing Chinese patent 2,082,40081U) is issued to Chinese inventor. The utility model relates to a kind of novel intelligent hardware wallets, including the positioning system being arranged in hardware wallet apparatus body, positioning system includes first singlechip, lithium battery, Anneta module, GSM locating module M160, WIFI module, A/D module, SIM card, electronic switch chip, loudspeaker and LED light, GSM locating module M160 power end is electrically connected with lithium battery output end, GSM locating module M160 is electrically connected with Anneta module, GSM locating module M160 is electrically connected by A/D module with the control terminal of electronic switch chip, SIM card is in the sim card slot of GSM locating module M160; Electronic switch chip output end, electronic switch chip control terminal, WIFI module, loudspeaker and LED light are electrically connected with first singlechip respectively. The utility model solves the problems, such as to be difficult to recover after existing hardware wallet is lost.

Another patent on Digital cash hardware wallet based on two interfaces IC-card bearing Chinese patent 2,050,03731U is issued to Chinese inventor. The utility model discloses a digital cash hardware wallet based on two interfaces IC-card, including the coil, NFC interface chips, the metal contact, a I/O interface, a bluetooth modul, digit cryptographic module, microprocessor CPU and USB interface, microprocessor CPU connects NFC interface chips respectively, digital cash wallet memory area, digit cryptographic module, the transaction functional areas, the USB interface, bluetooth module and IO interface, NFC interface chips is connecting coil still, metal contact and bluetooth module are still connected respectively to the IO interface, numeral cryptographic module connects transaction functional areas and digital goods respectively than the wallet memory area other end. The utility model provides a be applied to the hardware wallet scheme of digital cash, combine bluetooth, USB interface and contact, non-contact card interfacing, can realize communicating by letter between hardware wallet and cell-phone, the computer, adopt two independent user data storage districts in the wallet, promptly digital cash wallet memory area and transaction functional areas to adopt hardware to encrypt feasible safe and reliable more.

Another patent on a kind of digital cash fingerprint hardware wallet bearing Chinese patent 2,064,80041U is issued to Chinese inventor. The utility model discloses a kind of digital cash fingerprint hardware wallet, is related to digital cash field. Digital finger-print hardware wallet is specifically included: Control module, master key generation module, secure storage module, key derivation module, signature blocks, communication interface modules, fingerprint module and power module; Control module is connected with signature blocks, master key generation module, fingerprint module and communication interface modules; Power module is all connected with other modules; Secure storage module is connected with master key generation module and key derivation module, and key derivation module is connected with signature blocks and control module. The digital cash fingerprint hardware wallet that the utility model is provided; the private key and transaction data that are used during data monetary operations are all subjected to safe storage and safeguard protection by hardware; the private key used is also completed within hardware to the signature of digital monetary operations information, and safety guarantee is provided for the digital cash of user.

There are multiple solutions that have been presented in prior art. However, these solutions are limited and restricted to their conventional systems. The current invention is focused on presenting a method for designing an algorithm to crypto wallet to hold cryptocurrency/transfer and an associated feature to get rewards for the users.

The current patent discloses a methodology to a wallet which is a special type of cryptocurrency wallet which stores the user's crypto currency safely and allows for its safe transmittal. Furthermore, the current invention also provides ways to get associated rewards once any transaction is successfully completed.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved method for securely designed wallet which is a special type of cryptocurrency wallet allows to store the user's cryptocurrency.

It is also the primary objective of the invention to provide a smart methodology on enhancing the useability and ease of use of wallet.

It is another objective of the invention to provide a system where the proposed assembly allows the user to operate a wallet and safe transmittal of currency.

It is also the object of the invention to provide an advance system which provides associated reward system once a transaction is successfully completed.

It is also the object of the invention to provide a method where earned rewards can be used to get gift card or exchange to different coin

It is further the objective of the invention to provide an advance system that is simple and convenient to implement and use.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 discloses the signup page of the system as per preferred embodiments of the invention.

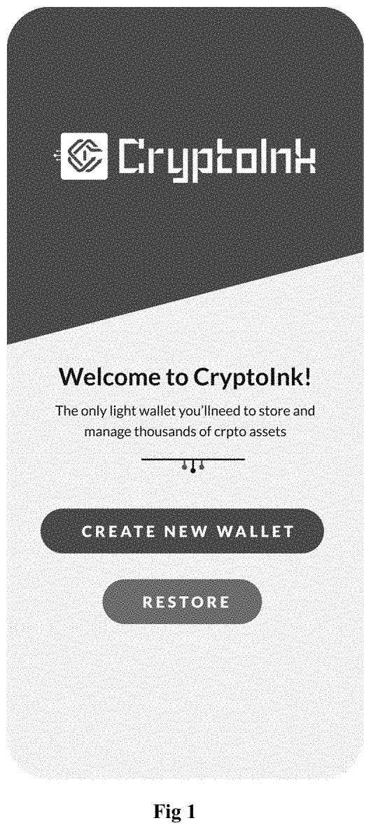

FIG. 2 discloses the wallet screen of the system as per preferred embodiments of the invention.

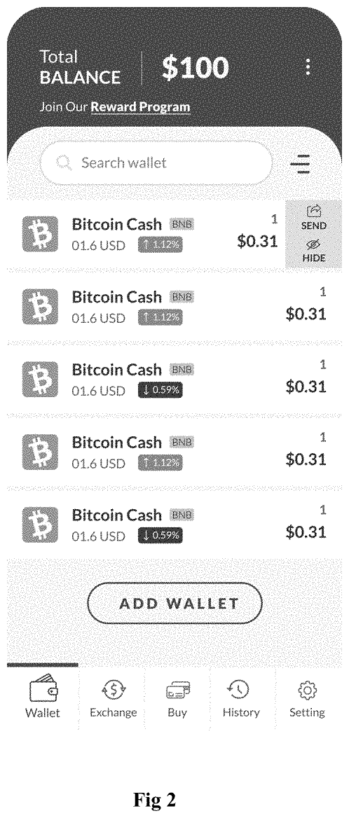

FIG. 3 discloses another view of the wallet screen of the system as per preferred embodiments of the invention.

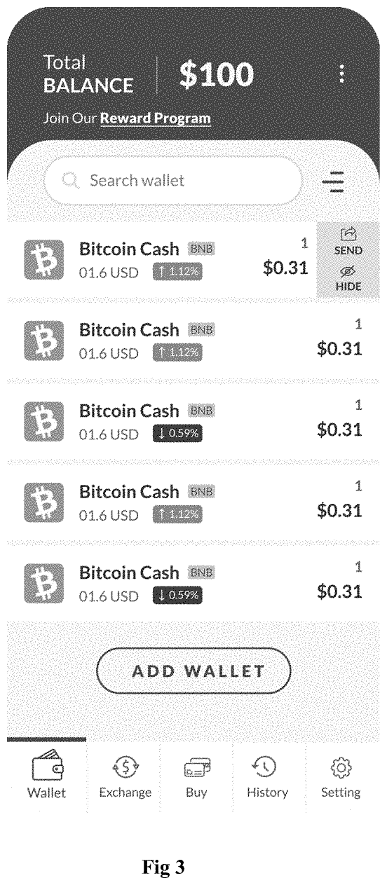

FIG. 4 shows multiple types of filters which can be utilized by member in their screen of the system as per preferred embodiments of the invention.

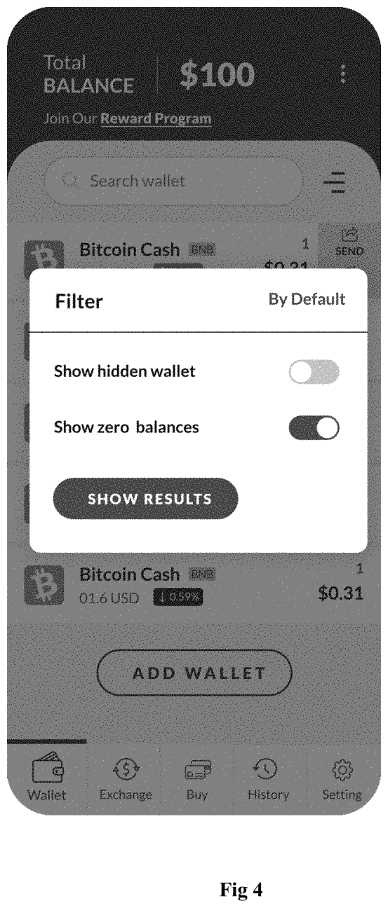

FIG. 5 discloses the wallet history screen of the system as per preferred embodiments of the invention.

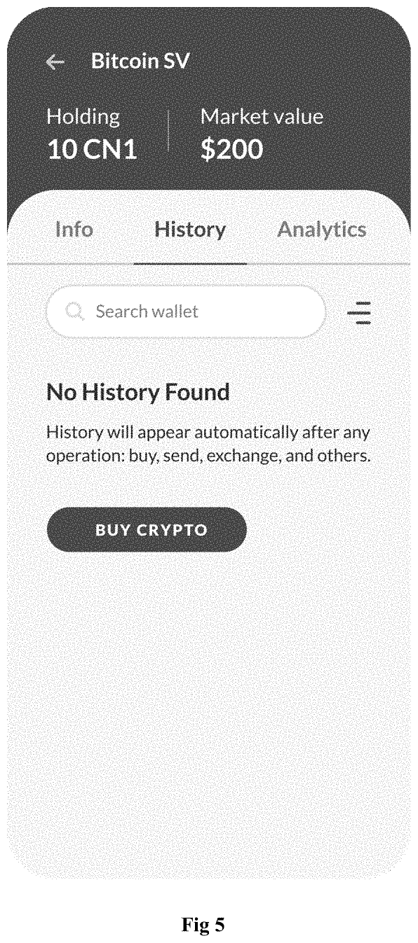

FIG. 6 discloses the exploded view of the wallet screen as per preferred embodiments of the invention.

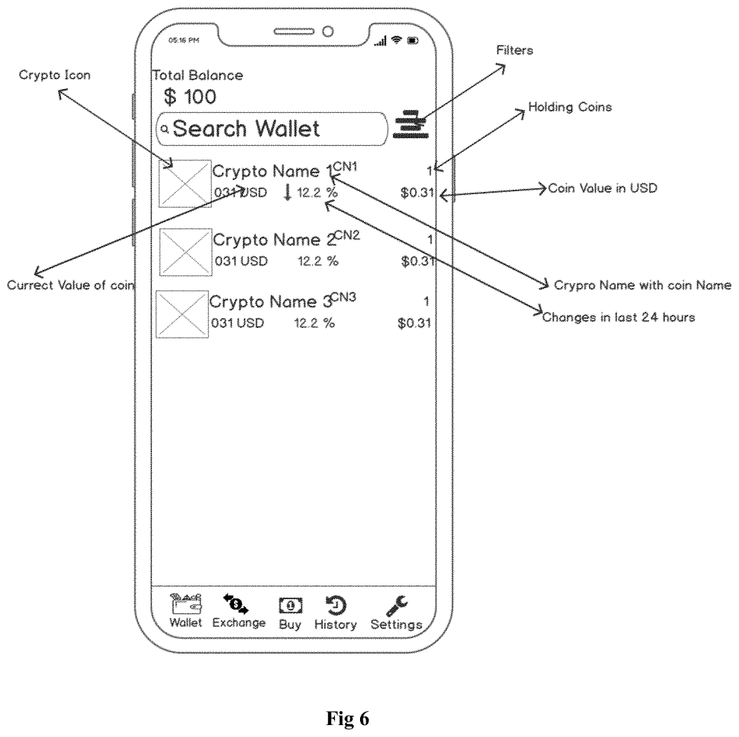

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced assembly of wallet which is a special type of cryptocurrency wallet which stores the user's private cryptocurrency in safe manner. It further allows the user to perform transactions and earn points.

The system as per its further embodiments also provides user the way to redeem points to get gifts or exchange to coins.

With the development of technology, more and more users manage digital goods using the digital wallet installed in electronic equipment Coin (such as bit coin and Lai Te coin etc.). Wherein, which is referred to as digital wallet equipment. The digital wallet is the wallet of block chain technology, and private key is the exclusive evidence for managing the digital cash in digital wallet.

Digital cash is the substitute money of electronic money form, and digital gold coin and password currency belongs to digital cash. The ideal money in virtual world cannot be fully equivalent to, because it is more applied in real exchange of goods and service. Password currency is the digital cash using cryptographic algorithm. It is non-that most of crypto operation has all continued to use information security field Often ripe asymmetric encryption system carries out the summary and signature of data. So, the safety of private key is just into digital cash The most important thing of development, current common solution he by private key be stored in application software or service provider service On device, also carried out when using on software or on server.

As per exemplary embodiments of the invention, a user can download the wallet application from their respective play store. Once activated user can sign in and send a registration message to the system either specifying a username or asking the system to generate a username. The system stores the user's contact information (such as a cell phone number) and username and registers the user. The system sends back an acknowledgement, possibly including a generated username. The user can register to receive updates from (i.e., to “follow”) other specified users and can otherwise configure his or her account with the system by sending configuration messages in specified formats to the system. A configuration message can contain, for example, message receipt preferences. In one embodiment, a new user is automatically registered with the system when the new user either joins a group (such as a follower's group) or sends a message. The new user can be given a system-generated username and an account with default preferences.

The system as per its further embodiments provides network data processing system with a network of computers in which the present invention may be implemented. The network data processing system contains a network, which is the medium used to provide communications links between various devices and computers connected together within network data processing system. Network may include connections, such as wire, wireless communication links, or fiber optic cables. In an example case, server is connected to network along with storage unit. In addition, are connected to network. These clients may be, for example, personal computers or network computers. The server provides data, such as boot files, operating system images, and applications to clients. Clients are the clients to server.

Once the user authorization is done, the user profile is created at back-end database. The present invention provides a method, apparatus, and computer instructions for providing real-time interaction of user with his/her smart wallet.

The assembly displays welcome screen where once the user is registered, finger print authorization is needed. If user isn't registered the new wallet formation process will be activated.

Once the user passes through the authorization step user can see the wallet, history, exchange, buy and setting options. The wallet options show coin details with rate. The coin details further can display information including but not limited to wallet details, copy address, share wallet details and show code options.

The coin details can also show the history and analytics screen to user. These screens show the transactions done by user and the analytics which can be filtered on daily, weekly, monthly or yearly basis.

The crypto currency can be transferred to other contacts or can be exchanged from one crypto coin to another coin. The transfer option can directly be accessed from main interface.

The system as per its additional embodiments allows user to buy crypto coin using flat money.

The system as per its other embodiments allows user to get rewards and utilize these rewards in various ways. A support platform, is also provided allowing user to access customer care team throughout 24 hours.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I. A computer-implemented method for creating and utilizing smart policies in a crypto currency management, the method comprising:
Generating, a user account via one or more processors, and maintaining the record at back-end server;
Publishing, by one or more processors, the use wallet information once the secured login is achieved;
Creating, by one or more processors, multiple types of information, history and analytics as per user account;
Processing, by one or more processors, the user authorized currency transfer process;
Publishing, by one or more processors, the rewards earned by user and methodology to earn multiple gift cards or coins.
